(19) United States
(12) Patent Application Publication
(10) Pub. No.: US 2015/0339775 A1
(43) Pub. Date: Nov. 26, 2015

(54) Investment portfolio performance presentation method

(71) Applicant: Anton Issinski, Coquitlam (CA)

(72) Inventor: Anton Issinski, Coquitlam (CA)

(21) Appl. No.: 14/285,648

(22) Filed: May 23, 2014

(51) Int. Cl. G06Q 40/06

(52) U.S. Cl. CPC G06Q 40/06

(57) ABSTRACT

A method of displaying statistically distributed investment portfolio return rate emphasizing the statistical nature of the return rate, its relation to the portfolio holdings and the method of avoiding the misrepresentation caused by systematic errors is described.

### BACKGROUND OF THE INVENTION

One most important value that describes investment performance over historical time interval is the rate of return for such investment. This value is usually a statistical value with a logo-normal distribution.

For a sake of simplicity however, the statistical aspect of it is frequently reduced to presenting only the expected average, while the second order parameter like deviation mentioned less often.

On the other hand, mentioning just the expected average without the deviation can be not enough informative for using even with simple mathematical models of investment portfolio management.

For example, knowing that the investment tool ‘A’ yields 10% annually and the investment initial cash value is $1000, one can not derive with the dollar value of the investment amount in the tool ‘A’. But if the deviation for the yield is known to be say 40%, then the first order formula will suggest buying about $625 worth of the tool ‘A’.

Similar, it does not make much sense to compare tools A and B if only yields for them are known. If tool A yield is 10% and tool B yield is 8%, we still cannot say which one is better if their deviations are not known. But if we know that deviation for A is 40% and for B it is 20%, by buying twice more of tool B, we will receive 16% yield at the same risk level as if we would buy the tool A.

On the other hand, all the portfolio performance values are normally obtained from the historical data. In some cases it would be the actual portfolio performance and in other cases it will be the performance obtained by a some form of portfolio management simulation process.

Such simulation process will naturally require a set of assets such as stocks to be selected in the portfolio for the management. This selection process will tend to favour stocks that have longer and richer history than assets that were withdrawn for their performance reasons. It will create systematic errors in portfolio performance estimation algorithm.

### BRIEF SUMMARY OF THE INVENTION

In this invention a colour intensity suggested to be used to inform the investor that he is dealing with the statistically distributed value rather than the exact value and to use the colour intensity to approximately describe the statistical distribution function. Displaying the implied return rate of an asset in the portfolio suggested as a special case of the return rate displaying. Finally, the method to cancel the effects of the calculation systematic errors in the return rate display is suggested.

### DETAILED DESCRIPTION OF THE INVENTION

In claim 1, this invention suggests a simple graphic presentation of a statistical value such as an investment yield in a form of a bar with its centre position representing value's expected average and the bar's colour intensity approximately proportional to the probability distribution function of that value. In such presentation, it is emphasized that the value is a statistical value that cannot be expressed as an exact amount, but only with some degree of probability. The width (or height) of the bar will reflect the deviation of the value's distribution.

A reverse analysis of the investment portfolio is also suggested to represent a link between the risks, the expected profits and current portfolio holdings. Because the optimum amount of some investment asset in the portfolio is well defined by tool's expected yield and deviation, the inverse algorithm can calculate what would be the yield to make the present amount of the asset in the portfolio optimum, if its deviation is known. In claim 2, such inverse method obtained ‘implied yield’ describes what investor is implicitly expecting from the investment asset once it is allocated in specified amount in the investment portfolio.

To avoid misrepresentation caused by systematic error in the mean value for the portfolio management method performance presentation, a second, benchmark performance is displayed. Claim 3 declares that instead of displaying the correct value for the benchmark, the benchmark performance containing the same systematic error should be displayed. In this case, if the portfolio management method did not introduced any benefit to the investor, the portfolio performance and the benchmark performances will look the same.

### DESCRIPTION OF IMAGES

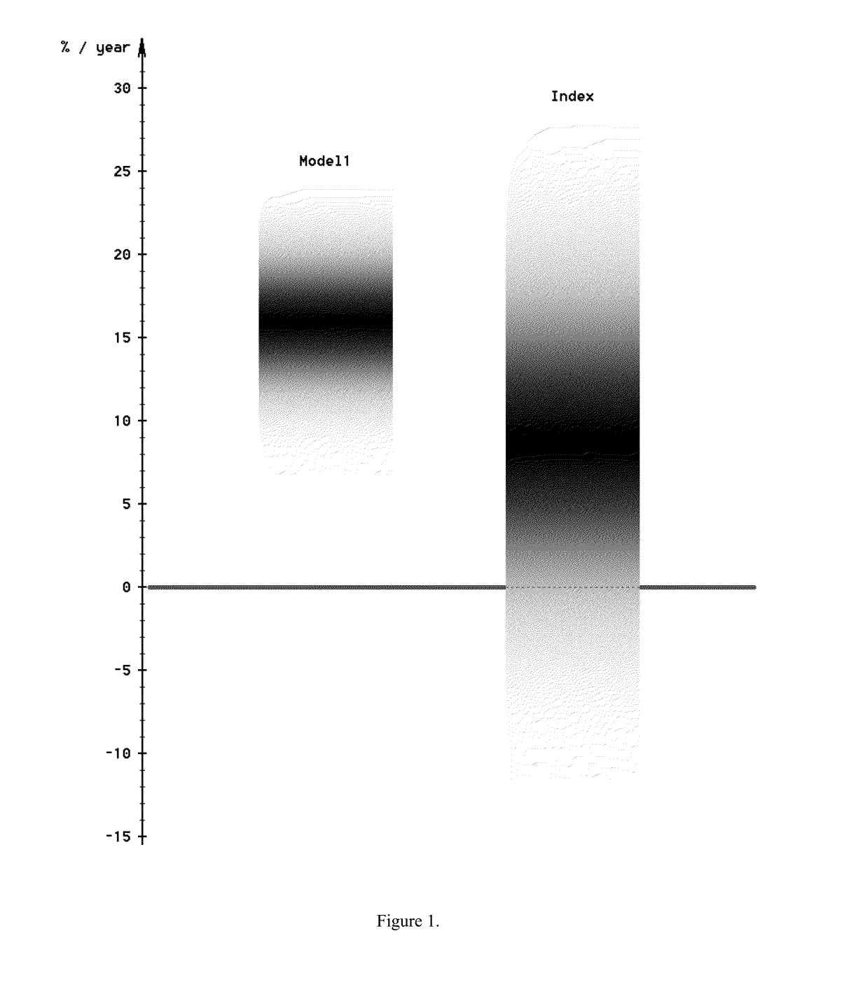

Graphical image on FIG. 1 shows two statistically distributed values. Bar on the left represents the performance of an investment tool labelled “Model1” and the bar on the right represents the performance of a tool labelled “Index”.

1. A method of displaying investment tool performance comprising a graphical image where one dimension of the image is plurality of possible values that the investment performance can take, and the image colour in this dimension that depends on the probability distribution function of the investment performance value.

2. A method of representing investment portfolio characteristics comprising an investment asset with a known expected deviation in the future, a known allocated de facto amount of the asset in the portfolio, a method of calculating the expected price change that would make de facto amount optimum for the given portfolio allocation and representing such calculated expected price change as the portfolio characteristics.

3. A method of displaying investment management strategy performance comprising of:
1. An investment asset or set of investment assets that could be selected by using some criteria that is not available at some historical moment M2,
2. Historical investment data for the asset (1) from some historical moment M1 to another moment M3 such that moment M1 is before moment M2 and the moment M1 is before moment M3,
3. A method of managing the investment assets (1),
4. A method of estimating investment performance of method (3) using historical data (2),
5. A systematic estimation error in the performance estimation method (4) caused by the criteria from (1),
6. A method of estimating investment performance of assets (1) using historical data (2), assets (1) some known predefined trivial management method and the same factors that leaded to the systematic estimation error (5),
7. A method of displaying performance (4) and (6) in a manner where they can be compared to each other.
